(19) United States
(12) Patent Application Publication
(10) Pub. No.: US 2019/0207767 A1
(43) Pub. Date: Jul. 4, 2019

(54) BLOCK CHAIN SUPPORTING MULTIPLE ONE-WAY FUNCTIONS USED FOR VERIFICATION OF BLOCKS

(71) Applicant: Kyu Tae AHN, Sungnam-si Gyeinggi-do (KR)

(72) Inventor: Kyu Tae AHN, Sungnam-si Gyeinggi-do (KR)

(21) Appl. No.: 16/098,849

(22) PCT Filed: May 2, 2017
(86) PCT No.: PCT/KR2017/004691

§ 371 Date: Nov. 3, 2018

(30) Foreign Application Priority Data
May 3, 2016 (KR) 10-2016-0054419

(51) Int. Cl. H04L 9/32

(52) U.S. Cl. CPC H04L 9/3236; H04L 2209/56; H04L 2209/38

(57) ABSTRACT

The present disclosure provides a method of a node device for generating blocks, comprising acquiring one or more transactions not stored in a blockchain, determining whether or not a new hash function is required for the one or more transactions, preparing the new hash function, generating a block data for the one or more transactions, calculating a hash value of the block data by the new hash function, generating a block comprising the hash value and the block data, and transmitting the block such that the block is stored in the blockchain.

### TECHNICAL FIELD

This disclosure relates to a blockchain supporting multiple one-way functions used for verification of blocks.

### BACKGROUND ART

Traditional electronic financial transactions are conducted in a way that individuals make a contact for transactions with trusted institutions such as banks and governments, which may be called as a centralized financial system that a central server take a role to prove and manage the transactions.

Recent financial systems use digital currency based on a blockchain and are implemented in a decentralized architecture where all network participants share and archive transactions. A paper entitled “Bitcoin: A peer-to-peer Electronic Cash System” by Satoshi Nakamoto, published in 2008, discloses an electronic currency system operated in a way of peer-to-peer such that the centralized financial institutions are not involved in the transactions, and the paper also discloses that the currency system may solve the double spending issue based on cryptographic functions and suggests that a decentralized node in the system may receive coins as an incentive for providing its computation power for mining process.

In general, node devices participating in a blockchain system with a decentralized structure are required to support the same cryptographic algorithms and protocols. A node device in this blockchain system may perform cryptographic operations such as proof-of-work (POW) competing with other node devices, and the system may provide compensation to a node that can provide the operation result first. In such a case, a high-performance node device, such as a node equipped with an application specific integrated circuit (ASIC) chip for the specific cryptographic algorithm, may monopolize the mining process using the computation power such that the node can easily take a favorable position as compared with other node devices.

### DISCLOSURE

### Technical Problem

Thus, there is a need for changing some characteristics of the blockchain system such as its cryptographic algorithms in order to prevent high-speed devices designed designated for certain cryptographic operations from participating in the networks so that they cannot solely control the whole blockchain system.

In the current blockchain systems, the system software for main operations related to one-way functions and cryptographic functions are fixed in a static way. Therefore, in such a case if any of the main operations such as one-way function needs be changed, system administrator of each node devices should download and install a new software to replace the existing one so that the blockchain system may operate properly with the new features.

The present disclosure provides a way to change a plurality of one-way functions of the node devices in the blockchain system without manual updates by the system administrator while the nodes are in operation, such that the various issues in the individual node devices such as system management, security, and stability may be resolved.

Also, there is a need to notify each nodes of the characteristics changes since there is no centralized control server in the decentralized blockchain system.

### Technical Solution

In one embodiment, this disclosure provides a method of a node device for generating blocks. The method of the node device for generating blocks, comprising: acquiring one or more transactions not stored in a blockchain; determining whether or not a new hash function is required for the one or more transactions; preparing the new hash function; generating a block data for the one or more transactions; calculating a hash value of the block data by the new hash function; generating a block comprising the hash value and the block data; and transmitting the block such that the block is stored in the blockchain.

The method can include one or more aspects as follow. The determination of whether or not the new hash function is required is based on at least a portion of the one or more transactions. Or the determination of whether or not the new hash function is required is based on a transaction which involves a management wallet among the one or more transactions. Or the determination of whether or not the new hash function is required is an indicator for the hash function used in at least one of blocks stored in the blockchain. Or the indicator is included in a last block in the blockchain. Or the block data for the one or more transactions comprises an indicator for the new hash function. Or the block data is configured to comprise a hash value of a last block in the blockchain and a meta selector, the meta selector comprising an indicator for the new hash function. Or the block data is configured to further comprise an extra data field including an executable code of the new hash function, and the preparing the new hash function comprises: reading the executable code included in the extra data field according to the indicator for the new hash function. Or the block data is configured to further comprise an extra data field including location information of an executable code of the new hash function, and the preparing the new hash function comprises: acquiring the executable code based on the location information included in the extra data field according to the indicator for the new hash function. Or the preparing the new hash function comprises: loading the executable code on a virtual machine within the node device. Or the executable code is in the form of a byte code.

In another embodiment, this disclosure provides a method of a node device for validating blocks. The method of a node device for validating blocks, comprising: acquiring a block to be validated; checking an indicator for a new hash function included in the block; preparing an executable code for the new hash function according to the indicator for the new hash function; and validating the block by the executable code.

The method can include one or more aspects as follow. The preparing the executable code for the new hash function comprises: reading the executable code included in an extra data field in the block according to the indicator. Or the preparing the executable code for the new hash function comprises: acquiring the executable code based on location information of the executable code, the location information being included in an extra data field in the block according to the indicator.

In one embodiment, this disclosure provides a node device. The node device comprising: a communication unit configured to transmit and receive transactions and blocks with other node devices participating in a blockchain network; a storage unit configured to store the transactions and the blocks; and a control unit connected to the communication unit and the storage unit to process the transactions and the blocks. The control unit is further configured to execute a block generation program and a block validation program, and the block generation program comprises codes to execute steps comprising: acquiring one or more transactions not stored in a blockchain; determining whether or not a new hash function is required for the one or more transactions; preparing the new hash function; generating a block data for the one or more transactions; calculating a hash value of the block data by the new hash function; generating a block comprising the hash value and the block data; and transmitting the block such that the block is stored in the blockchain. The block validation program comprises codes to execute steps comprising: acquiring a block to be validated; checking an indicator for a new hash function included in the block; preparing an executable code for the new hash function according to the indicator for the new hash function; and validating the block by the executable code.

According to the exemplary embodiments disclosed in this document, a hash algorithm set as default in a blockchain system can be changed as needed. According to the exemplary embodiments disclosed in this document it is possible to inform each node device that a new hash algorithm will be used based on a hash meta selector included in a transaction or block. Accordingly, the blockchain system can change cryptographic algorithms without applying a hard fork, thereby maintaining a reliability of the entire blockchain system and reducing its security risks.

### DESCRIPTION OF DRAWINGS

FIG. 1 illustrates a blockchain system according to an embodiment of the present disclosure.

FIG. 2 is a block diagram of relations between blocks according to an exemplary embodiment of the present disclosure.

FIG. 3 is a block diagram of relations between transactions according to an exemplary embodiment of the present disclosure.

FIG. 4 is a flow chart showing a method of a node device for generating blocks according to an exemplary embodiment of the present disclosure.

FIG. 5 is an example of meta selector according to an exemplary embodiment of the present disclosure.

FIG. 6 is a flow chart showing a method of a node device for validating blocks according to an exemplary embodiment of the present disclosure.

FIG. 7 is a block diagram of a node device that generates and validates blocks in a blockchain according to an exemplary embodiment of the present disclosure.

### MODE FOR INVENTION

The technologies of the present disclosure can be applied to a blockchain system, but not limited thereto. The technologies of the present disclosure can be applied to any cryptographic device and system that the technical idea of the present disclosure may be applied to.

It should be noted that the technical terms used in the present disclosure are used only to describe specific embodiments and are not intended to limit the technical idea disclosed in the present disclosure. In addition, unless otherwise defined in the present disclosure, the technical terms used in the present disclosure should be construed in a sense that is generally understood by those having ordinary skill in the art to which the technology disclosed in the present disclosure belongs, and should not be construed in an excessively broad sense, or in an excessively narrow sense. In addition, when the technical term used in the present disclosure is a misleading technical term that does not accurately describe the technical idea disclosed in the present disclosure, the technical term should be understood to be replaced by technical term that can be understood by those having ordinary skill in the art to which the technology disclosed in the present disclosure belongs. In addition, the general terms used in the present disclosure should be construed in accordance with the predefined or prior context, and should not be construed in an excessively narrow sense.

As used in the present disclosure, terms including an ordinal number, such as first, second, or the like may be used to describe various configuration elements, but the configuration elements should not be limited by the terms. The terms are used only for the purpose of distinguishing one configuration element from another configuration element. For example, a first configuration element may be referred to as a second configuration element without departing from the scope of the present disclosure, and similarly, the second configuration element may also be referred to as the first configuration element.

Hereinafter, embodiments of the present disclosure will be described with reference to the accompanying drawings in more detail, and the same or similar elements are denoted by the same reference numerals or symbols regardless of the reference numerals or symbols, and redundant description thereof will be omitted.

In addition, in the following description of the present disclosure, when it is determined that detailed description of the related known technology can obscure the gist of the technology disclosed in the present disclosure, the detailed description thereof will be omitted. In addition, it should be noted that the attached drawings are only for easy understanding of concept of the technology disclosed in the present disclosure, and the technical idea should not be construed as limited by the appended drawings.

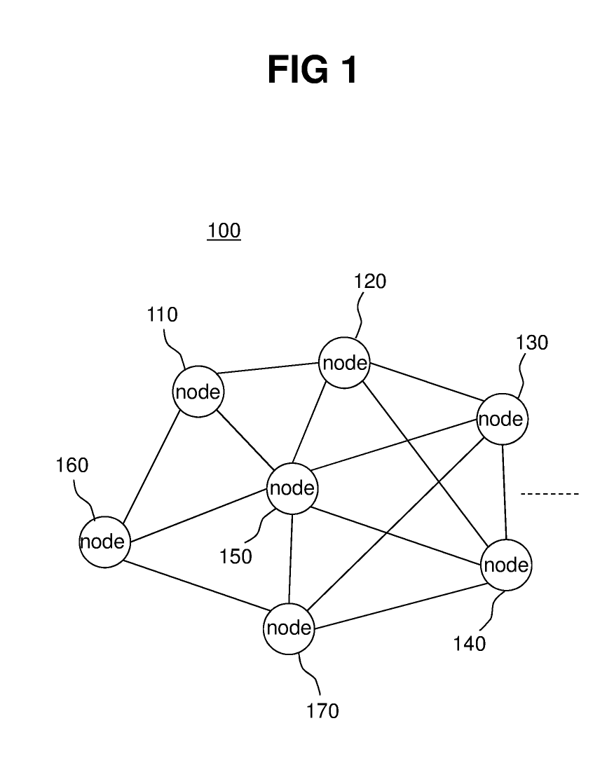

FIG. 1 illustrates a blockchain system according to an embodiment of the present disclosure.

Referring to FIG. 1, a blockchain system 100 is a decentralized network system comprising a plurality of nodes 110-170. The nodes 110-170 in the decentralized network 100 may be various types of electronic devices with a computation power such as a personal computer, a mobile terminal, and a dedicated electronic device.

In general, the decentralized network 100 may use a set of connected blocks called a blockchain to store and fetch information that is commonly known to every participating node. The nodes 110-170 can be divided into full nodes that can communicate with each other, which are responsible for storing, managing, and communicating the chain of blocks, and light nodes that can participate only in transactions. When referred to a node without further description herein, it is often, but not exclusively, referred to a full node that participates in a decentralized network and performs operations to create, store, or validate a blockchain.

Each block connected to the blockchain may comprise transactions within a certain period of time. Each node may manage transactions by creating, storing, or validating a blockchain according to their role.

According to an embodiment, the transaction may represent various types of transactions. In one embodiment, the transaction may be a financial transaction for indicating a status and change of the ownership of the cryptographic currency. In one embodiment, the transaction may be a physical transaction for indicating a status and change of the ownership of an object. The nodes performing transactions in the decentralized network 100 may have a pair of a private key and a public key that are cryptographically associated with each other.

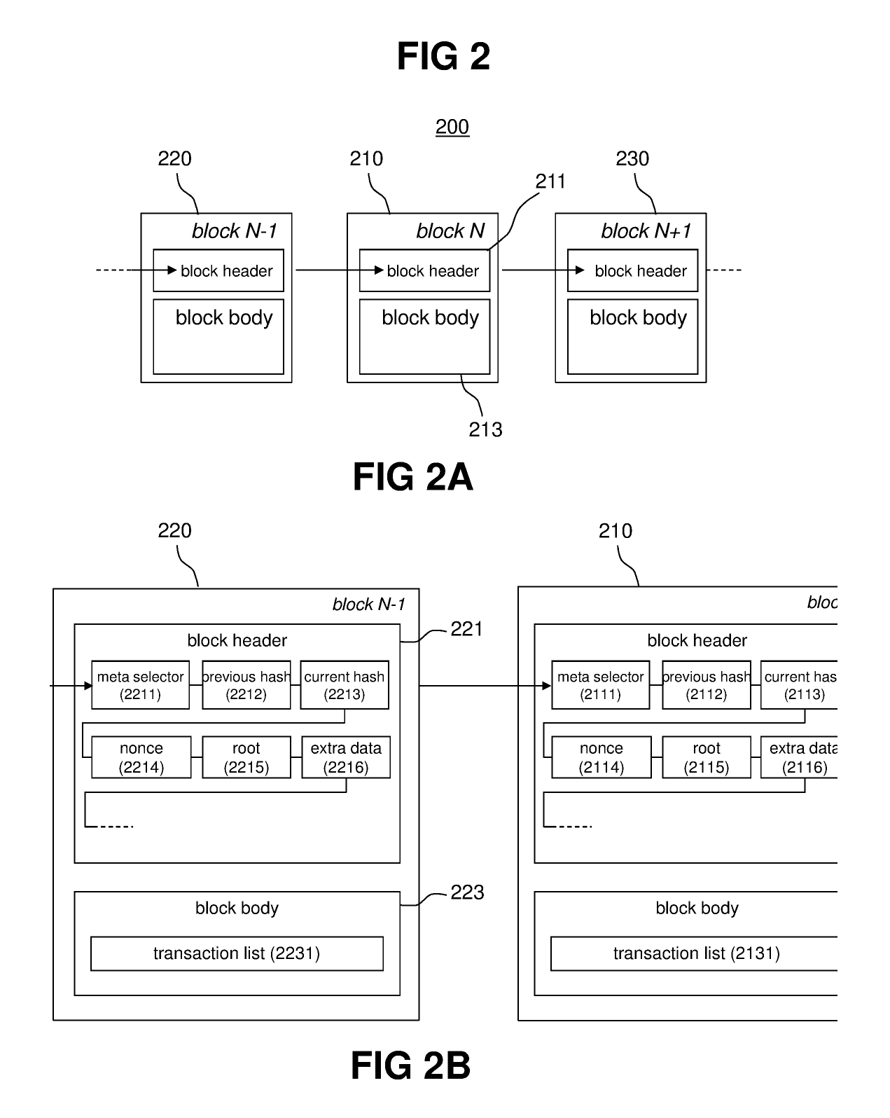

FIG. 2 is a block diagram of relations between blocks according to an exemplary embodiment of the present disclosure.

Referring to FIG. 2A, the blockchain 200 is a type of distributed database for one or more blocks 210, 220, and 230 that are sequentially connected. The blockchain 200 may be used for storing and managing transactions of a user in a blockchain system, and each node participating in the network of the blockchain system may generate a block and connect the block to the blockchain 200. FIG. 2 illustrates a limited number of blocks 210, 220, and 230, but the number of blocks that can be included in the blockchain is not limited thereto.

Each block included in the blockchain 200 may be configured to comprise a block header 211 and a block body 213. The block header 211 may comprise a hash value of the previous block 220 to indicate a connection relationship between the blocks. The connection relationship in the block header 211 is used in the process of validating a validity of the blockchain 200. The block body 213 may comprise data, for example, a transaction list or a transaction chain, that can be stored and managed in the block 210.

Referring to FIG. 2B, the block header 211 may comprise a meta selector 2111, a hash value 2112 of the previous block, a hash value 2113 of the current block, and a nonce 2114. In addition, the block header 211 may comprise a root 2115 indicating a header of a transaction list in a block.

The meta selector 2111 may comprise various options that can be applied to the current block 210. The meta selector 2111 may comprise identification information indicating a type of the one-way function used for the hash value 2113 of the current block.

As described above, the blockchain 200 may comprise one or more connected blocks. The one or more blocks may be connected to each other based on the hash value in the block header 211. The hash value 2112 of the previous block included in the block header 211 is the same value as the current hash value 2213 in the previous block 220, which is the hash value of the previous block 220. The one or more blocks are sequentially connected by the hash value of the previous block in each block header. The nodes that are participating in the decentralized network may validate the validity of the block based on the hash value of the previous block included in the one or more blocks so that tampering or modifying the contents in the already generated blocks is not feasible by a malicious single node.

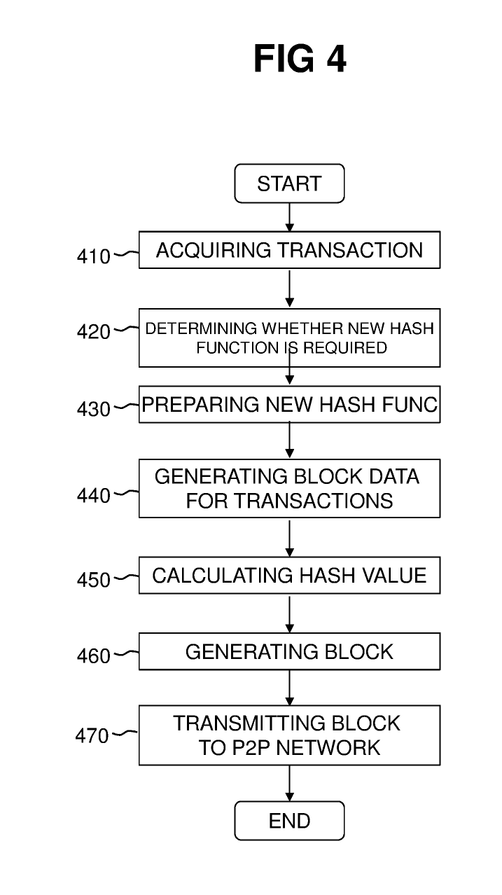

A block processing method according to an embodiment in the disclosure may determine a one-way function for proof-of-work (POW) or proof-of-stake (POS) included in a blockchain based on the meta-selector 2111. The meta selector 2111 may be referred to as a meta version selector (MVS). The meta selector 2111 in this disclosure is described as representing the information of the one-way function, but it is not limited thereto, and the meta-selector 2111 may be implemented to comprise other meta information of the blockchain system. Examples of the meta selector will be described below with reference to FIG. 4.

In one embodiment, the block header 211 may comprise an extra data field 2116. The extra data field 2116 may comprise an executable code for the one-way function according to the meta-selector 2111. The extra data 2116 field may comprise location information such as an address indicating the location of the executable code for the one-way function according to the meta-selector 2111. The node device can acquire the executable code with reference to the location information.

The block body 213 may comprise a transaction list 2131. The transaction list 2131 may be a list of blockchain based transactions. For example, the transaction list 2131 may include a record of financial transactions made in the blockchain based financial system. The transaction list 2131 may be expressed in a tree form, and the transaction list 2131 records, for example, the amount of money transferred from user A to user B in a form of list, and the storing length within the block may vary based on the number of transactions included in the current block.

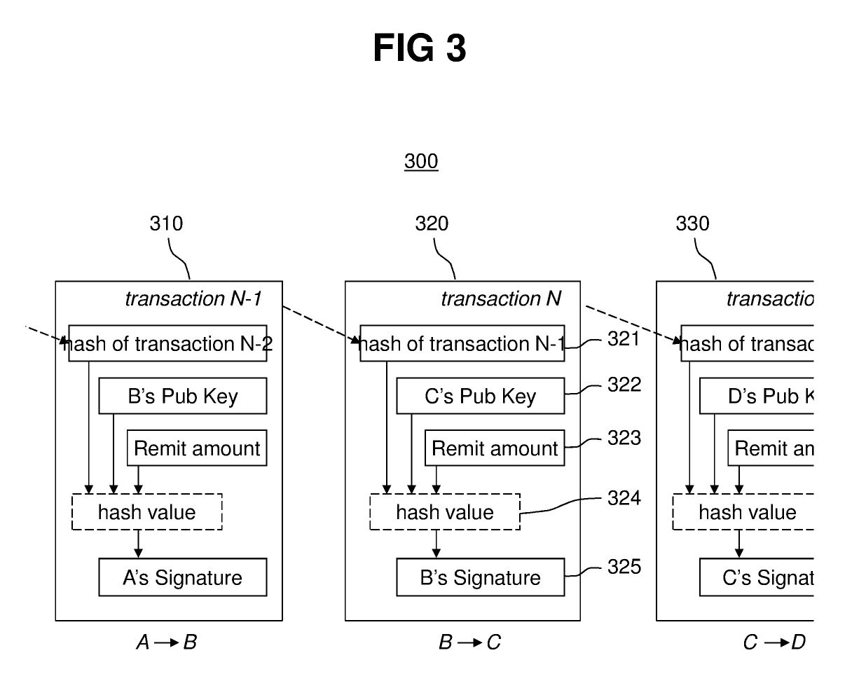

The nodes participating in the decentralized network have the same blockchain, and the same transaction is stored in the block. The block containing the transaction list is shared across the network so that all participating nodes can validate the blockchain. The transaction list will be described with reference to FIG. 3.

FIG. 3 is a block diagram of relations between transactions according to an exemplary embodiment of the present disclosure.

The transaction list 300 described with reference to FIG. 3 is a collection of one or more transactions 310, 320, 330 that are connected to each other. Each of the one or more transactions may comprise a hash value of the previous transaction, recipient information, remittance amount and a signature of the sender. The recipient information may be a public key of the recipient.

The transaction list is sequentially linked by the hash value of the previous transaction. The exemplary transaction list of FIG. 3 comprises a transaction 310 for user A to remit to user B, a transaction 320 for user B to remit to user C, and a transaction 330 for user C to remind user D.

An exemplary transaction N 320 for a transaction that user B remits to user C comprises a hash value 321 of transaction N-1 310 corresponding to a hash 321 of the previous transaction, a public key 322 of the recipient user C, and amount of remittance 323.

The transaction N 320 may also comprise a signature 325 of the sender, user B. The signature 325 of the sender may be a value obtained by signing the hash value 324 by the sender's private key, wherein the hash value 324 is calculated by using the hash 321 of the previous transaction, the recipient's public key 322, and the remittance amount 323 as input of hash function. To prevent a risk of generating a false remittance transaction from another person's account into its account, a hash value for each item to be used for verification is obtained and a signature of the hash value signed by the sender's private key is included. The signature of the sender can then be validated by nodes participating in the network during the validation process.

New currencies that can be used in a blockchain system may be issued by a mining process, and the mining process is to validate a transaction. The validation process is a method of providing rewards to a node that finds a nonce that satisfies a specific condition and generates a block, which may be referred to as a proof of work.

For example, the mining process is to repeat a hash function, which is a one-way function, to obtain a hash value of inputs such as a hash value of the previous block, transaction information and a nonce until the hash value that satisfies a specific condition is found. The number of hash values satisfying the specific condition is limited, so that the amount of money to be issued to the entire blockchain-based financial system can be limited.

As described above, in a decentralized blockchain system, when a particular node device has a relatively high computational power compared to other nodes, a relatively high-performance node can perform the proof of work first, thereby the issue of monopolizing the mining process in the blockchain based system may be raised. For example, a node device implemented with an ASIC specialized for the mining process may monopolize the POW process compared to a general electronic device.

In a decentralized environment, some node devices implemented to have a very high-performance device specialized in the mining process may cause to lower a credibility of the entire blockchain system if they dominate the coin mining process. In such a case, the credibility and security of the blockchain system may be improved by decentralizing the monopoly of mining and the provision of hash power.

If only a single one-way function is used for the blockchain system, the specialized tools for the mining process can be developed and distributed. Therefore, if a blockchain system can support a plurality of one-way functions, the risk of developing a very high-performance device specialized in mining the coin using an ASIC chip or the like will be reduced. If various computing node with general tools participate in validating hash values, the credibility and security of the blockchain can be enhanced.

In addition to the change in the one-way function, changes in other META information such as reducing a block generation cycle for a blockchain system, transient transaction overload response, changing a policy for system reliability of participating nodes, changing information on the linkage of the current blockchain to a side chain (a blockchain system created for a separated use), SW improvement information of the current participating node device, and notice of release information may be happened. In such a case, there can be raised a hard fork issue that requires the use of a newer version of the software. To this end, the present disclosure discloses a measure to selectively use various meta information while avoiding the hard fork issue.

FIG. 4 is a flow chart showing a method of a node device for generating blocks according to an exemplary embodiment of the present disclosure.

In step 410, the node device may acquire one or more transactions which are not stored in a blockchain through a network of the blockchain system. A node participating in the blockchain network can perform a one-way function operation such as a hash function to generate a block for transactions occurring for a predetermined time. The node device may perform the next operations for generating a block for the one or more transactions received through the decentralized network.

In step 420, the node device may determine whether a new hash function for the one or more transactions is required.

In one embodiment, the node device may determine whether the new hash function is required based on at least a portion of the one or more transactions. To this end, the blockchain system may consider a specific type of transaction as a message to indicate a change of characteristics of the blockchain system in use. In one embodiment, when the node device detects, among the received transactions, a certain transaction that involves a management wallet, the node device may consider it as a message to indicate that there are some changes in the characteristics of the blockchain system such as a new hash function is required. The management wallet may be, for example, the wallet account for the participant assigned as a software maintainer. That is, when the node device detects, among the received transactions, a transaction of a specified amount, e.g. 0.1 coin, from the address specified by the software maintainer to its own address or other address, the node device may determine that the new hash function is required based on such a transaction.

In one embodiment, the node device may consider transactions involving a plurality of management wallets as a message indicating that there are some changes in the characteristics of the blockchain system. has occurred for security reasons.

On the other hand, in one embodiment, the management node generates a management transaction comprising a wallet address of a predetermined management node; and transmits the management transaction to another node participating in the blockchain network to indicate that the function of the blockchain system has been updated.

In yet another embodiment, the node device may determine whether the new hash function is required based on an indicator for a hash function used in at least one of the blocks stored in the blockchain. For example, if the node device confirms that the last block on the stored blockchain uses a different algorithm than the hash algorithm in use, it can be considered that a new hash function is required. In this case, the node device may refer to an indicator for the new hash function used in the last block.

When it is considered that the same hash algorithm as before is used according to the above determination, the node device can continue to use the same algorithm in use.

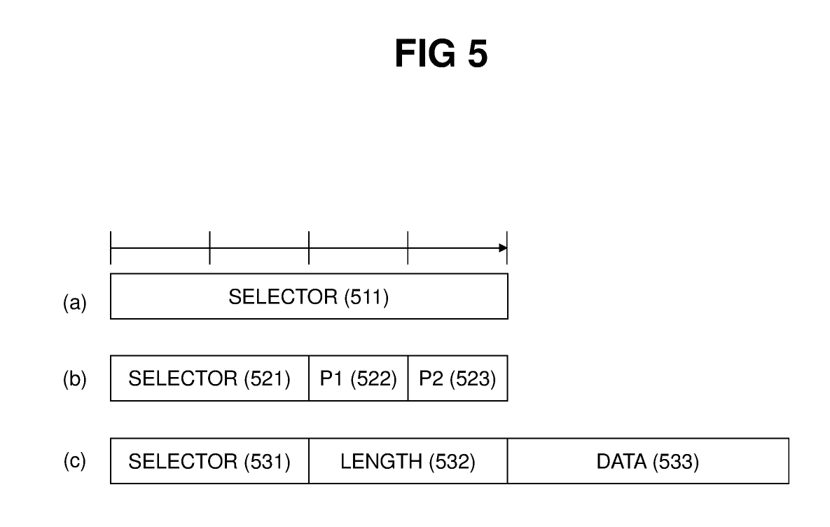

In step 430, if it is determined that the new hash function is required according to the determination above, the node device may prepare the new hash function. If the new hash function is already installed in the node device, the node device can simply designate the new hash function as the hash function in use and execute the new hash function. In addition, when the node device stores the executable code of the new hash function, the node device can install and execute the executable code of the new hash function. Also, when the node device has the location information of the new hash function, the node device can download the executable code with reference to the location information, and install and execute the executable code. This will be described later with reference to FIG. 5.

In addition, the preparation of the new hash function, by the node device, may comprise loading the executable code on a virtual machine within the node device. The executable code may be in the form of a byte code, and the executable code may be referred to as a decentralized application (Dapp).

In step 440, the node device may generate block data for the one or more transactions. The node device may generate a block as described with reference to FIG. 2 and FIG. 3. The block generated by the node device may be divided into a block header and a block body. In one embodiment, the block header may comprise an indicator for the new hash function for a hash calculation of the current block for other node devices to perform the validation process. The block data generated in the above step may be used as an input of the new hash function to be executed later to obtain the current hash value of the block. Accordingly, the block data may comprise a previous hash value for indicating a connection with the last block in the blockchain. In addition, the block data may comprise a meta selector including an indicator for a new hash function.

In one embodiment, the block data generated by the node device may be further configured to comprise an extra data field including executable code of the new hash function. In this case, the preparation of the new hash function in step 430 may comprise reading the executable code included in the extra data field according to the indicator for the new hash function.

In one embodiment, the block data generated by the node device may be configured to further comprise an extra data field including location information of an executable code of the new hash function. In this case, the preparation of the new hash function in step 430 may comprise obtaining the executable code based on the location information included in the extra data field according to the indicator for the new hash function.

In step 450, the node device may calculate a hash value for the block data by performing the new hash function. Thereafter, the node device may generate a block comprising the hash value of the current block and the block data. Thereafter, in step 470, the node device may transmit the generated block to the blockchain network to be stored in the blockchain.

FIG. 5 is an example of meta selector according to an exemplary embodiment of the present disclosure.

In one embodiment, the meta-selector may be in the form of a selector field having a specified length. Referring to FIG. 5A, the meta-selector field value 511 may be to identify a predetermined type of one-way function. For example, if the meta-selector field value has a specific value such as 0x00000000 or 0xFFFFFFFF in 4 bytes, it may indicate a block hash algorithm used as default in the blockchain system.

In one embodiment, the meta-selector may comprise a selector field and a parameter having a specified length. Referring to FIG. 5B as an example, the meta-selector may be of a form comprising a selector field 521 in a specified length and one or more parameters 522 and 523. In this case, the selector field 521 identifies a predetermined type of one-way function, and the one or more parameters 522 and 523 may be parameters required for the one-way function. The number of the one or more parameters are not limited to two as shown in FIG. 5.

In one embodiment, the meta-selector may be configured to comprise a selector field having a specified length and a variable parameter. Referring to FIG. 5C, the meta-selector may comprise a selector field 531 of a specified length, length information 532, and data 533. For example, the data 533 of the size indicated by the length 532 may be provided as a parameter necessary for a predetermined one-way function indicated by the selector field 531.

In one embodiment, the format of the remaining meta-selectors may be determined based on at least a portion of the selector field included in the meta-selector. For example, based on the value of two bytes in the most significant byte of the meta-selector, the characteristics of the data of the remaining meta-selector two bytes is either to be used as the selector field value as described in FIG. 5 as an example or to be used as length information and data.

In one embodiment, the node device may refer to another field in a block comprising the meta selector based on at least a portion of data of the meta selector value in a step of a validation or a block generation. For example, the field used for the one-way function according to the meta-selector may be an extra data field 2116 described with reference to FIG. 2B. For example, when the upper one byte of the meta-selector is a value other than 0x00, the node device that processes the meta-selector may check the notification such as the changes in the blockchain system and the software update and may apply them based on the extra data field in the block data comprising the meta selector.

In one embodiment, when the value of the meta-selector field corresponds to a predefined value, the node device may determine a one-way function corresponding to the predefined value as an algorithm for block generation or validation. In such a case, the predefined value may be regarded as an identifier of the one-way function. If there is a change in the identifier for the one-way function on the blockchain system, the node device can store the change of the predefined value into the local storage of the node device and it may be referred if there is a need to perform the one-way function later.

In one embodiment, when the node device receives an identification number of an unknown one-way function, the node device may regard it as a new algorithm, and store the address (URL) contained in a specific field, for example, the extra data field, or an executable code, in the form of byte code, for the new algorithm, and it will be referred if the node device is required to perform the one way function later.

In the examples above, if the executable code of the one-way function in the block data cannot be stored in a specific field of the block, i.e. an extra data field, the node device can receive Dapp that performs the validation of the proof of work or proof of stake having the one way function based on the location information of the Dapp store in the specific field, and can perform the validation process of the proof of work and the proof of stake through the virtual machine in the node device.

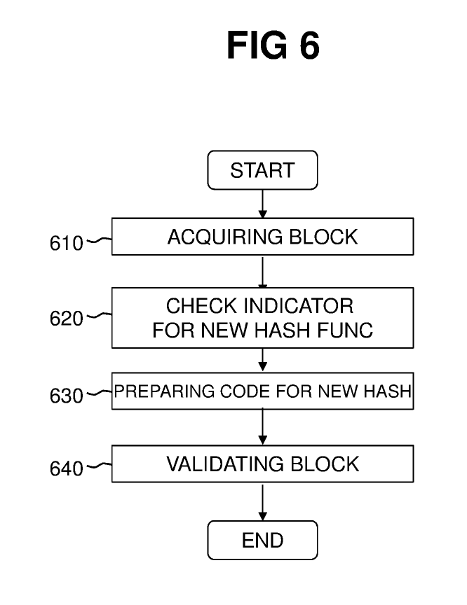

FIG. 6 is a flow chart showing a method of a node device for validating blocks according to an exemplary embodiment of the present disclosure.

In step 610, the node device which performs the validation process receives the block to be validated through the blockchain network. In step 620, the node device checks an indicator for the new hash function included in the block. The node device may determine whether a new hash function is required to validate the block based on the meta-selector field included in the block or the indicator for the new hash function contained in the meta-selector field.

In step 630, if it is determined that the new hash function is required to validate the block, the node device prepares the executable code of the new hash function according to the indicator for the new hash function. In one embodiment, the preparing the executable code for the new hash function comprises reading the executable code included in an extra data field in the block according to the indicator. In one embodiment, the preparing the new hash function comprises acquiring the executable code based on the location information included in the extra data field according to the indicator for the new hash function.

In step 640, the node device may validate the block by performing the executable code.

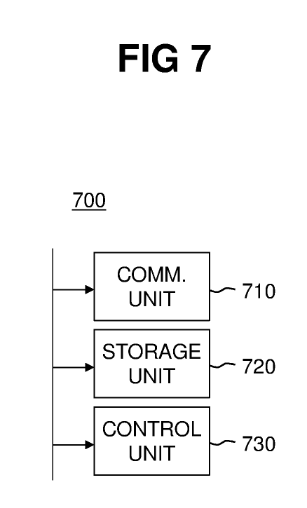

FIG. 7 is a block diagram of a node device that generates and validates blocks in a blockchain according to an exemplary embodiment of the present disclosure.

Referring to FIG. 7, the node 700 may comprise a communication unit 710 for transmitting and receiving transactions and blocks with other node devices participating in a blockchain network; a storage unit 720 for storing the transaction and the block; and a control unit 730 connected to the communication unit and the storage unit to process the transaction and the block.

The control unit 730 is further configured to execute a block generation program and a block validation program, and the block generation program comprises codes to execute steps comprising: acquiring one or more transactions not stored in a blockchain; determining whether or not a new hash function is required for the one or more transactions; preparing the new hash function; generating a block data for the one or more transactions; calculating a hash value of the block data by the new hash function; generating a block comprising the hash value and the block data; and transmitting the block such that the block is stored in the blockchain.

The block validation program comprises codes to execute steps comprising: acquiring a block to be validated; checking an indicator for a new hash function included in the block; preparing an executable code for the new hash function according to the indicator for the new hash function; and validating the block by the executable code.

Also, the node device 700 can be implemented to perform the methods disclosed in this disclosure.

The described exemplary embodiments are to be considered in all respects only as illustrative and not restrictive. The scope of the inventive concept is, therefore, indicated by the appended claims rather than by the foregoing descriptions.

1. A method of a node device for generating blocks, comprising:
acquiring one or more transactions not stored in a blockchain;
determining whether or not a new hash function is required for the one or more transactions;
preparing the new hash function;
generating a block data for the one or more transactions;
calculating a hash value of the block data by the new hash function;
generating a block comprising the hash value and the block data; and
transmitting the block such that the block is stored in the blockchain.

2. The method of claim 1, wherein the determination of whether or not the new hash function is required is based on at least a portion of the one or more transactions.

3. The method of claim 2, wherein the determination of whether or not the new hash function is required is based on a transaction which involves a management wallet among the one or more transactions.

4. The method of claim 1, wherein the determination of whether or not the new hash function is required is an indicator for the hash function used in at least one of blocks stored in the blockchain.

5. The method of claim 4, wherein the indicator is included in a last block in the blockchain.

6. The method of claim 1, wherein the block data for the one or more transactions comprises an indicator for the new hash function.

7. The method of claim 1, wherein the block data is configured to comprise a hash value of a last block in the blockchain and a meta selector, the meta selector comprising an indicator for the new hash function.

8. The method of claim 7, wherein the block data is configured to further comprise an extra data field including an executable code of the new hash function, and
wherein the preparing the new hash function comprises: reading the executable code included in the extra data field according to the indicator for the new hash function.

9. The method of claim 7, wherein the block data is configured to further comprise an extra data field including location information of an executable code of the new hash function, and
wherein the preparing the new hash function comprises: acquiring the executable code based on the location information included in the extra data field according to the indicator for the new hash function.

10. The method of claim 9, wherein the preparing the new hash function comprises: loading the executable code on a virtual machine within the node device.

11. The method of claim 10, wherein the executable code is in the form of a byte code.

12. A method of a node device for validating blocks, comprising:
acquiring a block to be validated;
checking an indicator for a new hash function included in the block;
preparing an executable code for the new hash function according to the indicator for the new hash function; and
validating the block by the executable code.

13. The method of claim 12, wherein the preparing the executable code for the new hash function comprises: reading the executable code included in an extra data field in the block according to the indicator.

14. The method of claim 12, wherein the preparing the executable code for the new hash function comprises: acquiring the executable code based on location information of the executable code, the location information being included in an extra data field in the block according to the indicator.

15. A node device comprising:
a communication unit configured to transmit and receive transactions and blocks with other node devices participating in a blockchain network;
a storage unit configured to store the transactions and the blocks; and
a control unit connected to the communication unit and the storage unit to process the transactions and the blocks,
wherein the control unit is further configured to execute a block generation program and a block validation program,
wherein the block generation program comprises codes to execute steps comprising:
acquiring one or more transactions not stored in a blockchain;
determining whether or not a new hash function is required for the one or more transactions;
preparing the new hash function;
generating a block data for the one or more transactions;
calculating a hash value of the block data by the new hash function;
generating a block comprising the hash value and the block data; and
transmitting the block such that the block is stored in the blockchain, and
wherein the block validation program comprises codes to execute steps comprising:
acquiring a block to be validated;
checking an indicator for a new hash function included in the block;
preparing an executable code for the new hash function according to the indicator for the new hash function; and
validating the block by the executable code.

16. A method of a management node for indicating a system update, comprising:
generating a management transaction comprising a wallet address of a predetermined management node; and
transmitting the management transaction to another node participating in a blockchain network to indicate a function update of a blockchain system.
